(19) United States
(12) Patent Application Publication
(10) Pub. No.: US 2009/0095723 A1
(43) Pub. Date: Apr. 16, 2009

(54) LASER PROCESSING METHOD

(75) Inventor: Kazuo Nakamae, Yokohama-shi (JP)

Correspondence Address: VENABLE LLP, P.O. BOX 34385, WASHINGTON, DC, 20043-9998, US

(73) Assignee: SUMITOMO ELECTRIC INDUSTRIES, LTD., Osaka (JP)

(21) Appl. No.: 12/237,947

(22) Filed: Sep. 25, 2008

(30) Foreign Application Priority Data
Oct. 2, 2007 (JP) 2007-259106

(51) Int. Cl. B23K 26/00

(52) U.S. Cl. 219/121.72

(57) ABSTRACT

The present invention relates to a laser processing method capable of arbitrarily controlling a concentration distribution of an assist gas supplied for an object having a complicated surface, together with a laser beam. In the case of laser-processing a tape-shaped cord including several coaxial cables, the method is applied for cutting ground lines surrounding each coaxial cable. Prior to a laser irradiation, at the tip portion of the cord, a flow pathway for the assist gas is ensured between the coaxial cables by removing the resin covering each surface of the coaxial cables. Since each coaxial cable has a non-flat shape, a first surface domain, on which the laser beam is incident at an approximate right angle, and a second surface domain, on which the laser beam is incident at a smaller angle, exist in each surface of the coaxial cables. The second surface domain constitutes part of a wall of the flow pathway for the assist gas, and therefore the concentration of the assist gas in the vicinity of the second surface domain increases rather than that of the assist gas in the vicinity of the first surface domain. As a result, a sufficient laser processing efficiency can be ensured even in the second surface domain on which a laser processing efficiency remarkably decreases.

### BACKGROUND OF THE INVENTION

1. Field of the Invention

The present invention relates to a laser processing method which laser-processes a surface of an object, such a cutting, etc., by irradiating an object with a laser beam of a predetermined wavelength while supplying an assist gas to the object.

2. Related Background Art

Conventionally, laser processing technologies have been used for processing, such as cutting of part of an object by irradiating a surface of the object with a laser beam of a predetermined wavelength. It is known that such laser processing technologies are effective in laser processing of a surface of the object while spraying the surface with an assist gas for improvement in processing efficiencies, especially processing rate. Such a conventional laser processing method is described, for example, in Toshiyuki Miyazaki, Hajime Miyazawa, Masao Murakawa, and Shunro Yoshioka, “Reza Kako Gijutsu (Laser Processing Technology)”, May 31, 1991, 1st Ed., pp. 54-56, Sangyo Tosho Kabushiki Kaisha.

### SUMMARY OF THE INVENTION

The present inventors have examined the conventional laser processing method, and as a result, have discovered the following problems.

That is, the conventional technology cannot afford sufficient laser processing to an object having a complicated surface, or areas a laser beam hardly reaches, such as a side surface of the object, thereby leaving some of the object unprocessed.

The present invention has been developed to eliminate the problems described above. It is an object of the present invention to provide a laser processing method comprising a structure capable of arbitrarily controlling a concentration distribution of an assist gas supplied for an object to be processed that is irradiated with a laser beam, in order to effectively achieve a laser processing even when the object has a complicated surface.

A laser processing method according to the present invention relates to a laser processing technology which laser-processes at least part of an object while supplying the object with an assist gas. The laser processing method comprises the steps of, at least, a preparation of the object to be laser-processed, a formation of a flow pathway for the assist gas, and a laser irradiation. In particular, the laser processing method according to the present invention is characterized by forming a flow pathway for the assist gas prior to a laser irradiation, in order to arbitrarily control the concentration distribution of the assist gas supplied together with the laser beam for the object.

In the formation step of the flow pathway for the assist gas, the flow pathway for the assist gas is formed in a process target area of the object prepared. The flow pathway makes the concentration of the assist gas, passing through the pathway, become higher than that of the assist gas in other areas. Such enrichment of the assist gas can be controlled, for example, by regulating the diameter of the pathway or the pressure of assist gas supplied. In the laser irradiation step, the process target area of the object is irradiated with a laser beam of a predetermined wavelength while the object is supplied with the assist gas. At the time of this laser irradiation, the laser beam may be scanned such that the irradiated area thereof on the surface of the object moves at a fixed rate.

Generally, in the case that the surface of the object is a complicated shape (that is, a non-perpendicular domain exists in the process target area of the object, with respect to the direction of the laser beam), a first surface domain, on which the laser beam is incident at an approximate right angle, and a second surface domain, on which the laser beam is incident at a smaller angle, exist in the surface of the object. The second surface domain, on which an incident light amount pre unit area is small rather than that on the first surface domain due to a smaller incident angle of laser beam, constitutes part of an inner wall of a flow pathway for the assist gas, as described above. Therefore, the assist gas predominantly passes through the preformed flow pathway and is enriched in the vicinity of the second surface domain. That is, the flow pathway provided in the object increases the concentration of the assist gas and thus improvements in processing efficiencies, for example, processing rate in the vicinity of the second surface. By this, the laser processing rate can be increased even in surface domains on which the irradiation amount of laser beam is small, such as the second surface domain, and therefore a laser processing can be effectively performed. In other words, the laser processing rate similar to that in the first surface domain can be achieved even in the second surface domain.

In the laser processing method according to the present invention, the object may include a plurality of elements arranged in an array style. In this case, in a process target area on each element, the element may have a polygonal cross section. More particularly, the object may include a tape-shaped cord which comprises: a plurality of coaxial cables arranged in an array style; and a resin integrally covering these coaxial cables.

In addition, in the laser processing method according to the present invention, the object may include a metal plate having a first major surface and a second major surface opposing the first major surface. In this case, a through hole, which communicates between the first major surface and the second major surface, is formed in the metal plate, as a flow pathway for the assist gas. That is, in the laser processing method, the process target area of the object is irradiated with the laser beam of a predetermined wavelength, while supplying the assist gas for the through hole in the object. During the laser irradiation, the laser beam is scanned such that the irradiated area thereof moves along the edge of the through hole while overlapping at least part of the edge of the through hole.

In the case that a planar object is pierced like this, conventional laser processing methods have resulted in tapering at opening edges. However, the laser processing method according to the present invention can prevent tapering at opening edges, with high accuracy and efficiency.

In the laser processing method according to the present invention, the assist gas preferably includes oxygen gas. Application of oxygen gas as the assist gas can increase the laser processing rate without adverse effect on regions other than the process target area of the object.

Furthermore, in the laser processing method according to the present invention, the assist gas is preferably supplied from one side of the object, and is discharged by suction at the other side of the object after passing through the flow pathway formed in the object. This matter can effectively increase the concentration of the assist gas in the second surface domain in the process target area of the object.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will be apparent to those skilled in the art from this detailed description.

### BRIEF DESCRIPTION OF THE DRAWINGS

FIGS. 1A to 1E show pre-processing steps of a first embodiment of a laser processing method according to the present invention;

FIG. 2 is a perspective view showing a structure of a tip portion of the object after the pre-processing steps in the laser processing method according to the first embodiment;

FIG. 3 shows laser processing steps of the laser processing method according to the first embodiment more particularly;

FIGS. 4A and 4B show post-processing steps of the laser processing method according to the first embodiment;

FIG. 5 is a perspective view that schematically illustrates a laser processing method according to a second embodiment; and

FIGS. 6A-6C show laser processing steps of the laser processing method according to the second embodiment more particularly.

### DESCRIPTION OF THE PREFERRED EMBODIMENTS

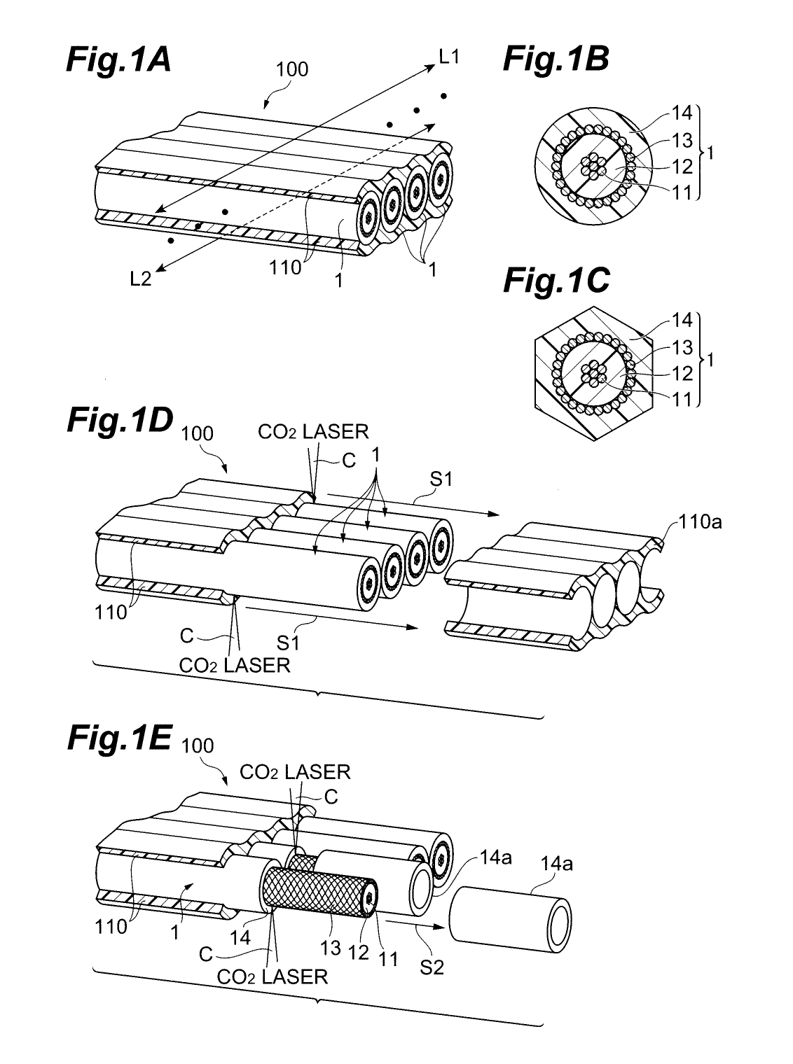

In the following, embodiments of the laser processing method according to the present invention will be explained in detail with reference to FIGS. 1A-1E, 2-3, 4A-4B, 5, and 6A-6C. In the description of the drawings, identical or corresponding components are designated by the same reference numerals, and overlapping description is omitted.

### First Embodiment

A first embodiment of the laser processing method according to the present invention will be described in reference to FIGS. 1A-1E, 2-3, and 4A-4B. In the first embodiment, a tape-shaped cord is prepared as an object to be laser-processed, which includes three coaxial cables arranged in parallel on the same plane and integrally covered with a laminating resin.

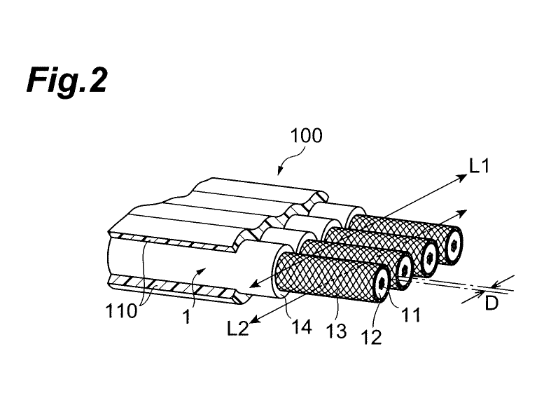

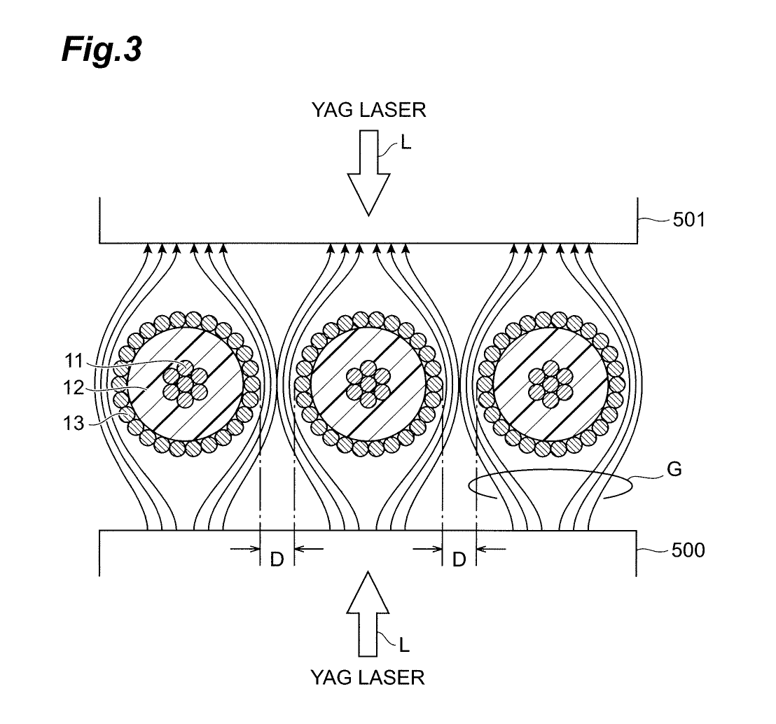

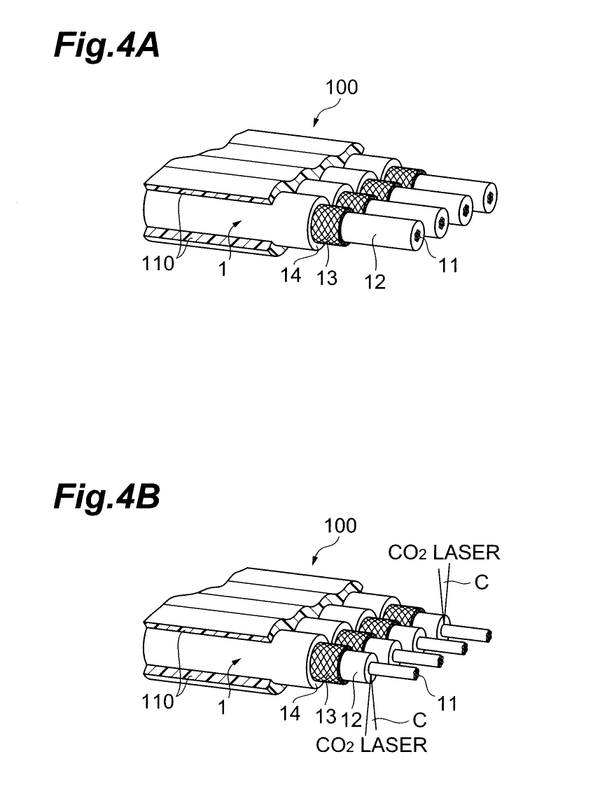

FIGS. 1A-1E show pre-processing steps of the laser processing method of according to the first embodiment. FIG. 2 is a perspective view that illustrates a structure of a tip portion of the object after the pre-processing steps in the laser processing method according to the first embodiment. FIG. 3 shows laser processing steps of the laser processing method according to the first embodiment more particularly. FIGS. 4A and 4B illustrate post-processing steps of the laser processing method according to the first embodiment.

As shown in FIG. 1A, a tape-shaped cord 100 has three coaxial cables 1, and a laminating resin 110 that integrally covers these coaxial cables 1. As shown in FIG. 1B, each of the coaxial cables 1 comprises a center conductor 11 disposed in the cable center, an insulating layer 12 provided on the outer periphery of the center conductor 11, a ground line 13 provided on the outer periphery of the insulating layer 12, and an insulating sheath 14 provided on the outer periphery of the ground line 13. The center conductor 11 and the ground line 13 are comprised of a conductive metal, for example, a tinned copper alloy. The insulating layer 12 is comprised of an insulating resin, for example, PFA or PET. Each of the coaxial cables 1 has a radius of 50 μm. As shown in FIG. 1C, each of the coaxial cables 1 may have a polygonal cross section. In the laser processing method according to the first embodiment, a laser beam is scanned over the upper surface of the tape-shaped cord (the object to be laser-processed) 100 such that the irradiated area thereof moves along the arrow L1 as shown in FIG. 1A. On the other hand, another laser beam is scanned over the lower surface of the tape-shaped cord such that the irradiated area thereof moves along the arrow L2.

The pre-processing steps of the laser processing method of according to the first embodiment are steps for ensuring a flow pathway for the assist gas that is supplied for the object during the subsequent step of laser processing. In the pre-processing steps, the surface of the laminating resin 110 is irradiated with laser beams C from CO₂ lasers along the arrows L1 and L2 in FIG. 1A such that the laminating resin 110 is cut into two parts. Then, the end part 110a of the cut laminating resin is pulled away from the tip portion of the tape-shaped cord 110 along the arrow S1 as shown in FIG. 1D. By this, the outer coatings 14 of the coaxial cables 1 is exposed.

Furthermore, the cable sheath 14 of each coaxial cable 1 is irradiated and cut with the laser beams C from CO₂ lasers, and then the end part 14a is pulled away from the tip portion of the tape-shaped cord 110 along the arrow S2 as shown in FIG. 1E.

The pre-processing steps expose the tip portion of the ground line 13 comprised of a conductive metal as shown in FIG. 2. In the laser processing method according to the first embodiment where the end part 14a of each cable outer coating 14 is pulled away as described above, resulting in a space D between two adjacent ground lines 13 in the tip portions of the coaxial cables 1, the space which acts as a flow pathway for the assist gas, a laser processing step of cutting the exposed ground line 13 in the tip portion of each coaxial cable 1 is performed using a YAG laser while the assist gas is sprayed.

That is, in the laser processing step, the laser beams L are radiated from both vertical directions of ground lines 13 in the tip portion of each coaxial cable 1 as shown in FIG. 3. As the laser beam L, a YAG laser (a wavelength of 1064 nm) is used, for example. The laser beam emitted from a light source is incident on the process target area of the object (the exposed tip portion of the ground line 13) through an optical system including a beam expander and a condenser lens. The beam expander collimates the laser beam after it expands the diameter of the laser beam. The condenser lens condenses the laser beam outputted from the beam expander and guides the beam to the surface of the object. The focal point of the laser beam L can be adjusted by controlling the optical system. Within the surface of the ground line 13 of the coaxial cable 1 shown in FIG. 3, on the upper and lower areas, belonging to the first surface domains on which the laser beam L is incident at an approximate right angle, the irradiation amount of laser beams L inevitably becomes large since the incident direction of the beams L is perpendicular to the plane where the coaxial cable 1 is disposed. On the other hand, the irradiation amount of laser beams L on the second surface domain between the adjacent coaxial cables 1 becomes small since the beams L are incident at a smaller angle.

As described above, in the case of the a tape-shaped cord 100 shown in FIG. 3, the upper and lower surfaces of each of the coaxial cable 1 are the first surface domain, and the surfaces of the coaxial cables 1 facing each other at the space D are the second surface domains that constitute part of an inner wall of the flow pathway for an assist gas.

In the laser processing step of the laser processing method according to the first embodiment, an assist gas supplier 500 is disposed under the coaxial cables 1, and supplies oxygen gas as the assist gas, as shown in FIG. 3. On the other hand, an assist gas aspirator 501 is disposed above the coaxial cables 1, and sucks the assist gas passing through the flow pathway formed, as described above, from the lower part to the upper part of the coaxial cable 1. In FIG. 3, the assist gas stream is illustrated by the solid line arrows.

The assist gas passing through the space between the coaxial cables 1 has a higher density as shown by the solid line arrows, and hence enriched in the vicinity of the flow pathway including the second surface domain, because the several spaces D between the coaxial cables 1 are smaller relative to those between the upper parts or the lower parts of the coaxial cables 1.

As described above, the assist gas with a fixed pressure discharged toward the flow pathway formed on the target tape-shaped cord 100 can enrich the assist gas in the vicinity of the second surface domain of the coaxial cable 1 where the beams L are incident at a smaller angle (the surface facing adjacent coaxial cables 1) more than that in the vicinity of the first surface domain of the coaxial cable 1 where the laser beams L are incident at an approximate right angle (the upper and lower parts of the coaxial cable 1). In this case, a processing-promoting effect of the assist gas can compensate for a reduction in the processing rate caused by the small irradiation amount of the laser beams L on the second surface domain. That is, enrichment of the assist gas enhances processing efficiencies of the laser processing. Consequently, even though the object has a complicated surface such that the second surface domain is present on which the laser beams L are incident at a smaller angle, the rate of processing by the laser beams L can be enhanced, and a sufficiently practical laser processing can be achieved without leaving some of the object unprocessed.

In the first embodiment, the tape-shaped cord 100 includes three coaxial cables 1, but any otherwise number of the coaxial cables can also produce similar effects.

### Second Embodiment

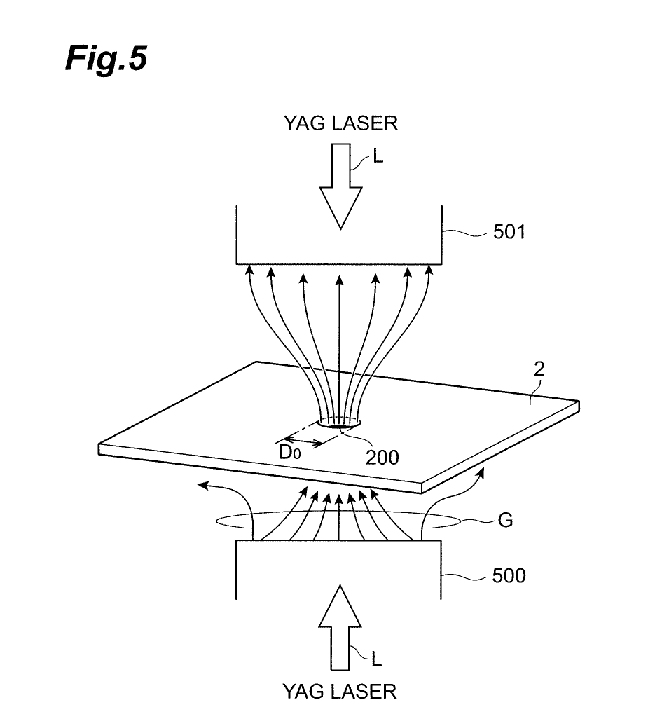

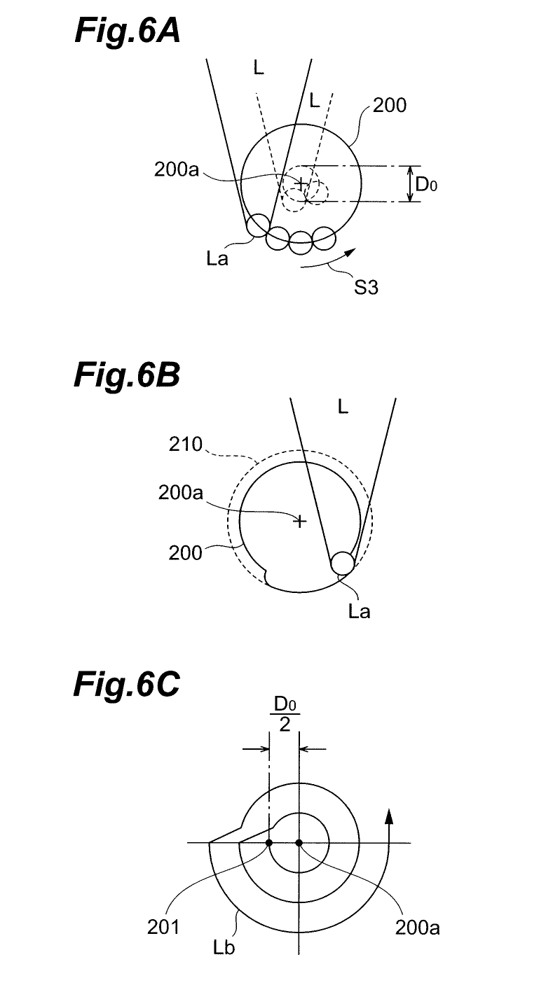

Next, a second embodiment of the laser processing method according to the present invention will be described. FIG. 5 is a perspective view that conceptually illustrates the laser processing method according to the second embodiment. FIGS. 6A-6C show laser processing steps of the laser processing method according to the second embodiment more particularly.

In the laser processing method according to the second embodiment, a conductive metal plate 2 is prepared as an object to be laser-processed. The prepared metal plate 2 is a copper palate having a thickness of 100 μm. The laser processing method according to the second embodiment includes piercing of this copper plate to form a hole with a predetermined diameter.

In the pre-processing steps of the laser processing method according to the second embodiment, a flow pathway for an assist gas is first formed in the copper plate 2. This flow pathway is a through hole 200 (the center 200a) having a diameter of D₀ as shown in FIG. 6A. At the time of viewing the upper surface of the copper plate 2, in the laser processing step, the laser beam L is scanned along the open edge of the through hole 200 formed as the flow pathway such that the irradiated area La overlaps the edge (see FIG. 6A). During the irradiation, the irradiated area La of the laser beam L moves in the direction shown by the arrow S3 in FIG. 6A. Consequently, the open diameter of the through hole 200 is gradually expanded, resulting in a through hole 210 having a larger open diameter (see FIG. 6B). The scan trajectory of the laser beam L is shown in FIG. 6C. In FIG. 6C, 201 is the starting point of scanning of the laser beam L.

In this laser processing step, both upper and lower surfaces of the copper plate 2 are irradiated with the laser beams L in the opposed vertical directions as shown in FIG. 5. As the laser beam L, a YAG laser (a wavelength of 1064 nm) is used, for example. The laser beam L emitted from a light source is incident on one surface of the target copper plate 2 through an optical system including a beam expander and a condenser lens. The beam expander collimates the laser beam L after it expands the diameter of the laser beam. The condenser lens condenses the laser beam L outputted from the beam expander and guides the beam to the copper plate 2. The focal point of the laser beam L can be adjusted by controlling the optical system as composed above. In the laser processing step, the copper plate 2 is pierced to form a through hole 210 having a desired diameter by moving the irradiated area La with the laser beam L and adjusting the focal point. Furthermore, in the laser processing method according to the second embodiment, an assist gas supplier 500 is disposed under the copper plate 2, and supplies oxygen gas as the assist gas to the through hole 200 of the plate 2 (as the flow pathway for the assist gas). An assist gas aspirator 501 is also disposed above the copper plate 2. This configuration enables the assist gas aspirator 501 to suck the assist gas passing through the through hole 200 formed as the flow pathway for the lower part to the upper part of the copper plate 2. In FIG. 5, the assist gas stream is illustrated by the solid line arrows.

Here, a structure of the through hole 200 formed by the laser beam will be described. Generally, in the case of a piercing step by using a laser beam, tapering occurs from the side close to the laser light source toward the opposite side. In the second embodiment, the copper plate 2 is irradiated with laser beams L from the opposed vertical directions, the diameter of the through hole 200 is tapered from the upper face of the copper plate 2 toward a mid portion of the copper plate 2 in a thickness direction, and from the lower face of the copper plate 2 toward the mid portion. Consequently, the irradiation amount of laser beams L on the side surface (the second surface domain) of the through hole in the vicinity of the mid portion of the copper plate 2, where the beams L are incident at an extremely smaller angle, becomes small. On the other hand, the irradiation amount of laser beams L on the upper and lower surfaces (the first surface domains) of the copper plate 2, where the laser beams L are incident at an approximate right angle, becomes large.

The assist gas passing through the through hole 200 of the copper plate 2 is enriched as shown by the solid line arrows in FIG. 5. Consequently, the assist gas is enriched more in the side surface of the through hole 200 of the copper plate 2 (the second surface domain), and especially in the mid portion than in the upper and lower surfaces of the copper plate 2 (the first surface domain).

As described above, a processing-promoting effect of the assist gas in the second embodiment can compensate for a reduction in the processing rate caused by a small irradiation amount of laser beam L on the second surface domain. That is, enrichment of the assist gas in the vicinity of the second surface domain that constitutes at least part of the inner wall of the flow pathway can enhance the rate of processing by the laser beam L even though the laser beam L is incident at a smaller angle. Sufficiently practical laser processing can also be achieved without leaving some of the object unprocessed.

The laser processing method according to the present invention can provide a more efficient surface processing for an object having a complicated surface.

The Embodiments of the present invention have been described, but the present invention is not limited to these embodiments, and various modifications thereof can be formed. For example, any laser that has a processing-promoting effect of the assist gas can be used in place of a YAG laser used as a laser beam in these embodiments. The optical system for irradiation with a laser beam can also be modified. The object to be laser-processed may be any material that allows laser processing with an assist gas and the type of the assist gas can be modified depending on the material of the object.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A method of laser processing which laser-processes at least part of an object while supplying said object with an assist gas, said method comprising the steps of:
preparing said object for laser processing;
forming a flow pathway in a process target area of said object prepared, said flow pathway making a concentration of the assist gas, passing through said flow pathway, become higher than that of the assist gas in the other area, when the assist gas is supplied to said object; and
irradiating said process target area of said object with a laser beam of a predetermined wavelength while supplying said object with the assist gas.

2. A method of laser processing according to claim 1, wherein said object includes a plurality of elements arranged in parallel on the same plane, and, in said process target area on each of said elements, each of said elements has a polygonal cross section.

3. A method of laser processing according to claim 1, wherein said object includes a tape-shaped cord which comprises: a plurality of coaxial cables arranged in parallel on the same plane; and a resin integrally covering said plurality of coaxial cables.

4. A method of laser processing according to claim 1, wherein said object includes a metal plate which has a first major surface and a second major surface opposing said first major surface, and
wherein, in said metal plate, a through hole communicating between said first major surface and said second major surface is formed as a flow pathway for said assist gas.

5. A method of laser processing according to claim 1, wherein the assist gas includes oxygen gas.

6. A method of laser processing according to claim 1, wherein the assist gas is supplied from one side of said object, and is discharged by suction at the other side of said object after passing through said flow pathway formed in said object.

7. A method of laser processing which laser-processes at least part of an object while supplying said object with an assist gas, said method comprising the steps of:
preparing a metal plate as said object for laser processing, said metal plate having a first major surface and a second major surface opposing said first major surface;
forming a through hole, which communicates between said first major surface and said second major surface, in a process target area as a flow pathway for the assist gas, said through hole making a concentration of the assist gas, passing through said through hole, become higher than that of the assist gas in the other area, when the assist gas is supplied to said object; and
irradiating said process target area of said object with a laser beam of a predetermined wavelength while supplying the assist gas to said through hole of said object, said laser beam being scanned such that an irradiated area moves along the edge of said through hole while overlapping at least part of the edge of said through hole.

8. A method of laser processing according to claim 7, wherein the assist gas includes oxygen gas.

9. A laser processing method according to claim 7, wherein the assist gas is supplied from one side of said object, and is discharged by suction at the other side of said object after passing through said through hole formed in said object.
